(19) United States
(12) Patent Application Publication
(10) Pub. No.: US 2013/0275453 A1
(43) Pub. Date: Oct. 17, 2013

(54) METHOD AND SYSTEM FOR PROVIDING TEMPORAL SEARCH SUGGESTIONS IN REAL-TIME

(71) Applicants: Manvesh VYAS, Sunnyvale, CA (US); Anand KISHORE, Sunnyvale, CA (US)

(72) Inventors: Manvesh VYAS, Sunnyvale, CA (US); Anand KISHORE, Sunnyvale, CA (US)

(73) Assignee: YAHOO! INC., Sunnyvale, CA (US)

(21) Appl. No.: 13/448,399

(22) Filed: Apr. 17, 2012

(51) Int. Cl. G06F 17/30

(52) U.S. Cl. CPC G06F 17/3097
USPC 707/767

(57) ABSTRACT

A method and system for providing temporal search suggestions in real-time. The method includes obtaining real-time data from one or more websites. The method also includes processing the real-time data to detect one or more trending topics associated with the real-time data, and to extract a plurality of events from the real-time data. Further, the method includes storing the plurality of events along with associated timestamps. Moreover, the method includes providing one or more temporal search suggestions based on the trending topics and the plurality of events, the one or more temporal search suggestions being responsive to a search query of a user. The system includes an electronic device, a communication interface, a memory, and a processor. The processor further includes a real-time data unit, a trending topic detector, an event extractor unit, and a search suggest unit.

### TECHNICAL FIELD

Embodiments of the disclosure relate to the field of providing temporal search suggestions in real-time.

### BACKGROUND

Currently, when a user submits a search query in a search box of a search engine, one or more search suggestions are displayed below the search box. However, the search suggestions are usually in random order and sometimes have no relation to each other. Further, the search suggestions are only based on traditional inputs to the search box, for example a search index and search queries. Existing search engines also take time to register real-time data and events.

In light of the foregoing discussion, there is a need for a method and system for an efficient technique to provide temporal search suggestions in real-time for real-time data and events.

### SUMMARY

The above-mentioned needs are met by a method, a computer program product and a system for providing temporal search suggestions in real-time.

An example of a method of providing temporal search suggestions in real-time includes obtaining real-time data from one or more websites. The method also includes processing the real-time data to detect one or more trending topics associated with the real-time data, and to extract a plurality of events from the real-time data. Further, the method includes storing the plurality of events along with associated timestamps. Moreover, the method includes providing one or more temporal search suggestions based on the trending topics and the plurality of events, the one or more temporal search suggestions being responsive to a search query of a user.

An example of a computer program product stored on a non-transitory computer-readable medium that when executed by a processor, performs a method of providing temporal search suggestions in real-time includes obtaining real-time data from one or more websites. The computer program product also includes processing the real-time data to detect one or more trending topics associated with the real-time data, and to extract a plurality of events from the real-time data. Further, the computer program product includes storing the plurality of events along with associated timestamps. Moreover, the computer program product includes providing one or more temporal search suggestions based on the trending topics and the plurality of events, the one or more temporal search suggestions being responsive to a search query of a user.

An example of a system for providing temporal search suggestions in real-time includes an electronic device. The system also includes a communication interface in electronic communication with the electronic device. The system further includes a memory that stores instructions, and a processor. The processor includes a real-time data unit that obtains real-time data from one or more websites, a trending topic detector that detects one or more trending topics associated with the real-time data, an event extractor unit that extracts a plurality of events from the real-time data, and a search suggest unit that provides one or more temporal search suggestions based on the trending topics and the plurality of events.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 is a block diagram of an environment, in accordance with which various embodiments can be implemented;

FIG. 2 is a block diagram of a server, in accordance with one embodiment;

FIG. 3 is a block diagram of a processor, in accordance with one embodiment;

FIG. 4 is a flowchart illustrating a method of providing temporal search suggestions in real-time, in accordance with one embodiment; and

FIG. 5 is an exemplary illustration of temporal search suggestions for a search query, in accordance with one embodiment.

### DETAILED DESCRIPTION OF THE EMBODIMENTS

The above-mentioned needs are met by a method, computer program product and system for providing temporal search suggestions in real-time. The following detailed description is intended to provide example implementations to one of ordinary skill in the art, and is not intended to limit the invention to the explicit disclosure, as one or ordinary skill in the art will understand that variations can be substituted that are within the scope of the invention as described.

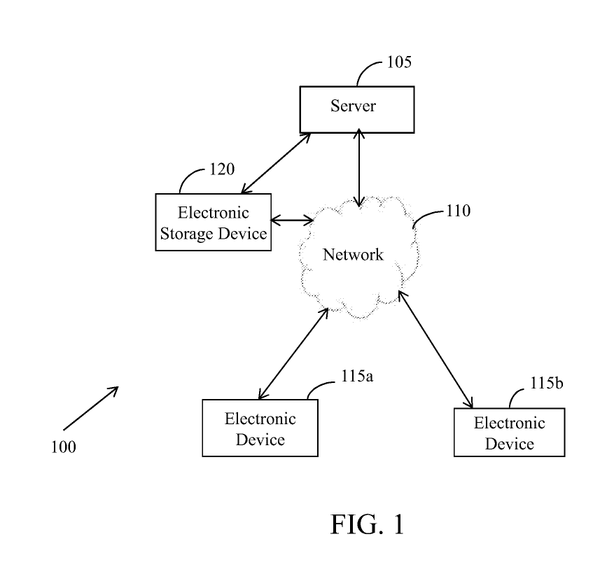

FIG. 1 is a block diagram of an environment 100, in accordance with which various embodiments can be implemented.

The environment 100 includes a server 105 connected to a network 110. The environment 100 further includes one or more electronic devices, for example an electronic device 115a and an electronic device 115b, which can communicate with each other through the network 110. Examples of the electronic devices include, but are not limited to, computers, mobile devices, tablets, laptops, palmtops, hand held devices, telecommunication devices, and personal digital assistants (PDAs).

The electronic devices can communicate with the server 105 through the network 110. Examples of the network 110 include, but are not limited to, a Local Area Network (LAN), a Wireless Local Area Network (WLAN), a Wide Area Network (WAN), internet, and a Small Area Network (SAN). The electronic devices associated with different users can be remotely located with respect to the server 105.

The server 105 is also connected to an electronic storage device 120 directly or via the network 110 to store information, for example real-time data from one or more websites, and one or more trending topics associated with the real-time data.

In some embodiments, different electronic storage devices are used for storing the information.

The server 105, for example a Yahoo!® server, obtains real-time data from one or more websites. The server 105 processes the real-time data to detect one or more trending topics associated with the real-time data, and to extract a plurality of events from the real-time data. The server 105 further stores the events along with associated timestamps. A user of an electronic device, for example the electronic device 115a, subsequently submits a search query in a search box. The server 105 then provides one or more temporal search suggestions based on the trending topics and the events, in response to the search query.

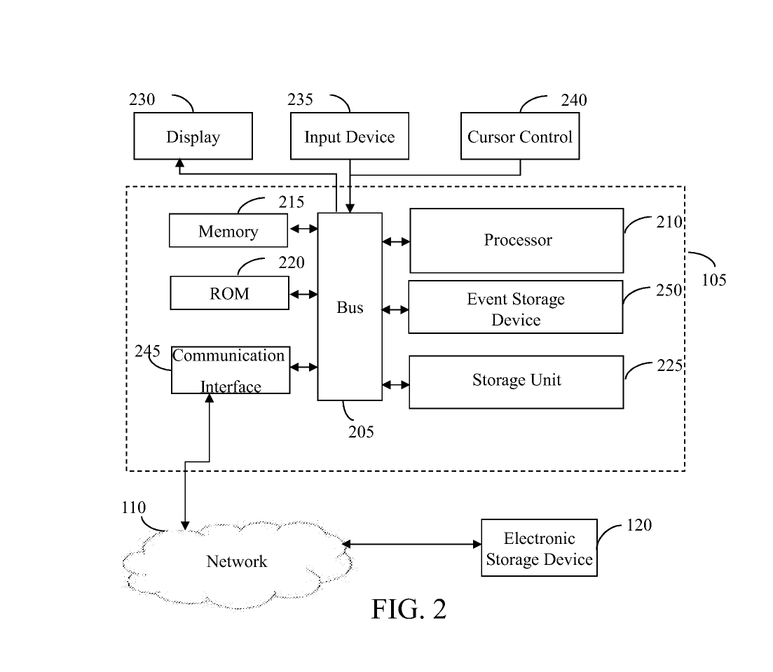

The server 105 including a plurality of elements is explained in detail in conjunction with FIG. 2.

FIG. 2 is a block diagram of the server 105, in accordance with one embodiment.

The server 105 includes a bus 205 or other communication mechanism for communicating information, and a processor 210 coupled with the bus 205 for processing information. The server 105 also includes a memory 215, for example a random access memory (RAM) or other dynamic storage device, coupled to the bus 205 for storing information and instructions to be executed by the processor 210. The memory 215 can be used for storing temporary variables or other intermediate information during execution of instructions by the processor 210. The server 105 further includes a read only memory (ROM) 220 or other static storage device coupled to the bus 205 for storing static information and instructions for the processor 210. A storage unit 225, for example a magnetic disk or optical disk, is provided and coupled to the bus 205 for storing information, for example real-time data from one or more websites, and one or more trending topics associated with the real-time data.

The server 105 can be coupled via the bus 205 to a display 230, for example a cathode ray tube (CRT), and liquid crystal display (LCD) for displaying the webpage. An input device 235, including alphanumeric and other keys, is coupled to the bus 205 for communicating information and command selections to the processor 210. Another type of user input device is a cursor control 240, for example a mouse, a trackball, or cursor direction keys for communicating direction information and command selections to the processor 210 and for controlling cursor movement on the display 230. The input device 235 can also be included in the display 230, for example a touch screen.

Various embodiments are related to the use of the server 105 for implementing the techniques described herein. In some embodiments, the techniques are performed by the server 105 in response to the processor 210 executing instructions included in the memory 215. Such instructions can be read into the memory 215 from another machine-readable medium, for example the storage unit 225. Execution of the instructions included in the memory 215 causes the processor 210 to perform the process steps described herein.

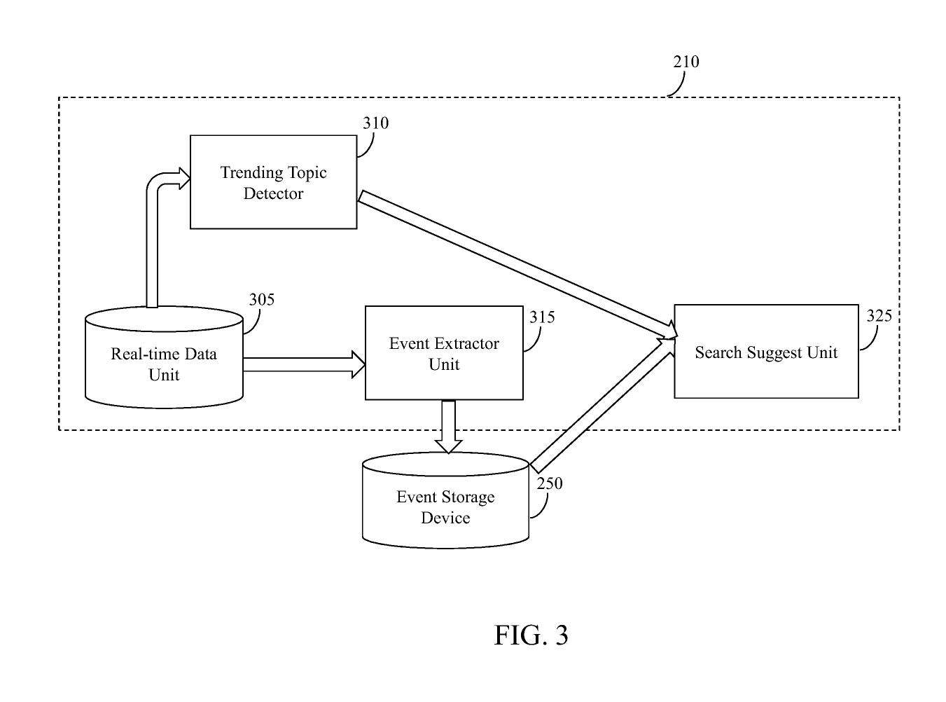

In some embodiments, the processor 210 can include one or more processing units, for example a real-time data unit, a trending topic detector, an event extractor unit, and a search suggest unit, for performing one or more functions of the processor 210. The processing units are hardware circuitry used in place of or in combination with software instructions to perform specified functions. The processor 210 including the processing units is explained in detail in conjunction with FIG. 3.

The term “machine-readable medium” as used herein refers to any medium that participates in providing data that causes a machine to perform a specific function. In an embodiment implemented using the server 105, various machine-readable media are involved, for example, in providing instructions to the processor 210 for execution. The machine-readable medium can be a storage medium, either volatile or non-volatile. A volatile medium includes, for example, dynamic memory, such as the memory 215. A non-volatile medium includes, for example, optical or magnetic disks, for example the storage unit 225. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic media, a CD-ROM, any other optical media, punchcards, papertape, any other physical media with patterns of holes, a RAM, a PROM, and EPROM, a FLASH-EPROM, any other memory chip or cartridge.

In another embodiment, the machine-readable media can be transmission media including coaxial cables, copper wire and fiber optics, including the wires that comprise the bus 205. Transmission media can also take the form of acoustic or light waves, such as those generated during radio-wave and infra-red data communications. Examples of machine-readable media may include, but are not limited to, a carrier wave as described hereinafter or any other media from which the server 105 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the server 105 can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by the memory 215 can optionally be stored on the storage unit 225 either before or after execution by the processor 210. All such media must be tangible to enable the instructions carried by the media to be detected by a physical mechanism that reads the instructions into a machine.

The server 105 also includes a communication interface 245 coupled to the bus 205. The communication interface 245 provides a two-way data communication coupling to the network 110. For example, the communication interface 245 can be an integrated services digital network (ISDN) card or a modem to provide a data communication connection to a corresponding type of telephone line. As another example, the communication interface 245 can be a local area network (LAN) card to provide a data communication connection to a compatible LAN. Wireless links can also be implemented. In any such implementation, the communication interface 245 sends and receives electrical, electromagnetic or optical signals that carry digital data streams representing various types of information.

The server 105 is also connected to the electronic storage device 120 to store the real-time data from one or more websites, and the trending topics associated with the real-time data.

The processor 210 in the server 105, for example a Yahoo!® server, obtains real-time data from one or more websites. The processor 210 processes the real-time data to detect one or more trending topics associated with the real-time data, and to extract a plurality of events from the real-time data. The processor 210 enables storage of the events along with associated timestamps, for example in an event storage device 250 present in the server 105. A user submits a search query in a search box. The processor 210 then provides one or more temporal search suggestions based on the trending topics and the events, in response to the search query.

FIG. 3 is a block diagram of the processor 210, in accordance with one embodiment.

The processor 210 includes one or more processing units, for example a real-time data unit 305, a trending topic detector 310, an event extractor unit 315, and a search suggest unit 320, for performing one or more functions of the processor 210.

The real-time data unit 305 obtains real-time data from one or more websites. Examples of the websites include, but are not limited to, social networking websites for example Twitter.

The trending topic detector 310 detects one or more trending topics associated with the real-time data. The trending topic detector 310 is used to figure out search terms in the search query for which one or more temporal search suggestions need to be displayed. The temporal search suggestions which need to be picked for displaying are determined by looking at temporal trends among the temporal search suggestions that include the search query of the user.

The event extractor unit 315 extracts a plurality of events from the real-time data. The events are stored along with metadata, for example timestamps, in the event storage device 250 of the server 105.

The search suggest unit 320 provides the temporal search suggestions based on the trending topics and the events. The temporal search suggestions are provided in response to the search query submitted by the user.

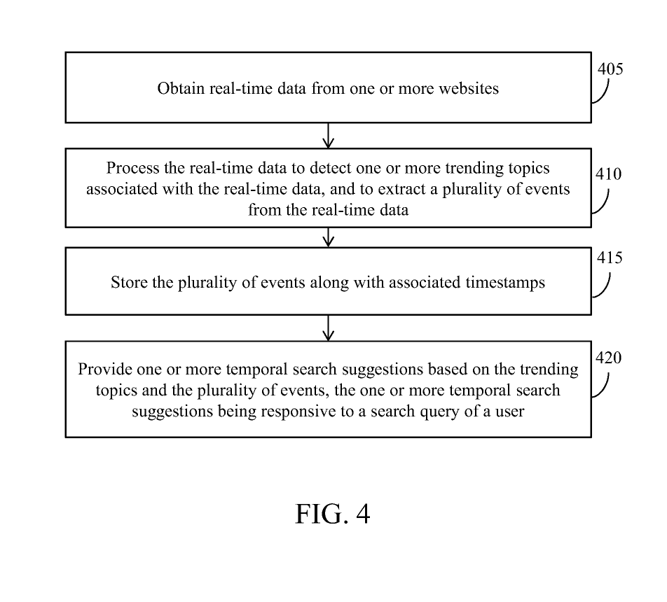

FIG. 4 is a flowchart illustrating a method of providing temporal search suggestions in real-time, in accordance with one embodiment.

At step 405, real-time data is obtained from one or more websites. Examples of the websites include, but are not limited to, social networking websites. Examples of the social networking websites include, but are not limited to, Twitter and Facebook. In one example, the real-time data is tweets from Twitter.

In some embodiments, the real-time data is obtained as a feed from the websites.

In some examples, the real-time data is submitted by one or more users associated with the websites. In other examples, the real-time data is submitted by one or more editors associated with the websites.

At step 410, the real-time data is processed. The real-time data is processed to detect one or more trending topics associated with the real-time data, and to extract a plurality of events from the real-time data. The trending topics can be defined as the topics that are currently highly searched on the internet. The events are extracted as triple data. The triple data can be defined as data extracted from each event. In some embodiments, the triple data includes a subject, a predicate, and an object.

In some embodiments, the triple data is extracted from each data point, for example from content of each tweet.

In some embodiments, the real-time data from the websites and the trending topics associated with the real-time data can be stored in an electronic storage device, for example the electronic storage device 120.

In other embodiments, the real-time data from the websites and the trending topics associated with the real-time data can be stored in a storage unit, for example the storage unit 225, in a server, for example the server 105. In one example, the server can be a centralized server or a distributed server of Yahoo!®.

At step 415, the events are stored along with associated timestamps. The events are stored in an event storage device, for example the event storage device 250. The timestamps are usually ordered either in ascending order or descending order.

In some embodiments, the events are stored along with some metadata other than the timestamps.

A user submits a search query in a search box, for example a Yahoo! search box. At step 420, one or more temporal search suggestions, responsive to the search query, are then provided based on the trending topics and the plurality of events. In one example, the temporal search suggestions include search suggestions along with the associated timestamps. The temporal search suggestions are provided using a search suggest unit, for example the search suggest unit 320. The temporal search suggestions can be displayed instantly below the search query.

In some embodiments, the temporal search suggestions are provided if one or more events are detected to be associated with at least one of the trending topics.

In some embodiments, the temporal search suggestions are displayed in extensible markup language (XML) format or in hypertext markup language (HTML) format.

In some embodiments, the temporal search suggestions can be stored in the electronic storage device 120 or the storage unit 225. The temporal search suggestions are subsequently retrieved from the electronic storage device 120 or the storage unit 225.

In some embodiments, the temporal search suggestions can include temporal search suggestions associated with one or more events that are related to each other.

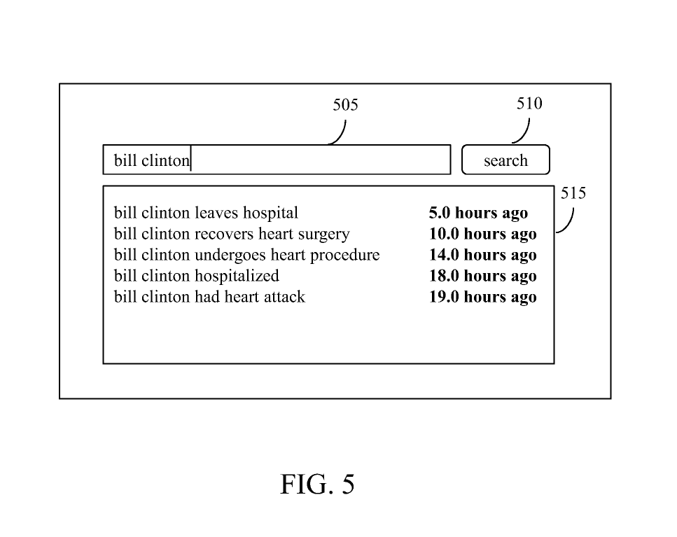

FIG. 5 is an exemplary illustration of temporal search suggestions for a search query, in accordance with one embodiment. A webpage, for example a Yahoo! webpage, has a search engine that includes a search box 505 and a search button 510. In an example, a user submits the search query ‘bill clinton’ in the search box 505. Before the user can click the search button 510, the search engine provides one or more search suggestions along with timestamps, referred to as temporal search suggestions 515. Some examples of the temporal search suggestions include, but are not limited to, bill clinton leaves hospital 5.0 hours ago, bill clinton recovers heart surgery 10.0 hours ago, bill clinton undergoes heart procedure 14.0 hours ago, bill clinton hospitalized 18.0 hours ago, and bill clinton had heart attack 19.0 hours ago.

The temporal search suggestions 515 are provided to the user based on one or more trending topics and a plurality of events which are procured from real-time data. The real-time data is obtained, by the server 105, from one or more websites, for example Twitter. The real-time data is then processed to detect the trending topics and to extract the events. The events are stored in the event storage device 250 along with the timestamps. The temporal search suggestions 515, associated with the search query, are then provided by the search suggest unit 325 based on the trending topics and the events.

In some embodiments, the temporal search suggestions 515 can include temporal search suggestions associated with one or more events that are related to each other. For example, the user submits the search query as ‘earthquake in japan’. Examples of the temporal search suggestions 515 can include, but are not limited to, earthquake in japan magnitude 5.0 hours ago, earthquake japan people dead 6.0 hours ago, earthquake japan fire 7.0 hours ago, earthquake in indonesia 9.0 hours ago, and tsunami asia 12.0 hours ago. In this example, the tsunami caused the earthquakes in indonesia and japan and hence the temporal search suggestions 515 are related.

The present disclosure provides temporal search suggestions more relevant to current events by obtaining real-time data from one or more websites. The present disclosure can also provide instant answers in the temporal search suggestions itself. The temporal search suggestions further provide an overview of events in order of occurrence, for a particular search query. Hence, the method and system in the present disclosure enables Yahoo! to efficiently use the real-time data to provide the temporal search suggestions.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A method of providing temporal search suggestions in real-time, the method comprising:
obtaining real-time data from one or more websites;
processing the real-time data to
detect one or more trending topics associated with the real-time data; and
extract a plurality of events from the real-time data;
storing the plurality of events along with associated timestamps; and
providing one or more temporal search suggestions based on the trending topics and the plurality of events, the one or more temporal search suggestions being responsive to a search query of a user.

2. The method as claimed in claim 1, wherein the real-time data is obtained as a feed.

3. The method as claimed in claim 1, wherein the plurality of events is extracted as triple data.

4. The method as claimed in claim 1, wherein the one or more temporal search suggestions comprises search suggestions along with the associated timestamps.

5. The method as claimed in claim 1, wherein providing the one or more temporal search suggestions comprises:
detecting if one or more of the plurality of events is associated with at least one of the trending topics.

6. The method as claimed in claim 1, wherein the user submits the search query in a search box.

7. A computer program product stored on a non-transitory computer-readable medium that when executed by a processor, performs a method of providing temporal search suggestions in real-time, comprising:
obtaining real-time data from one or more websites;
processing the real-time data to
detect one or more trending topics associated with the real-time data; and
extract a plurality of events from the real-time data;
storing the plurality of events along with associated timestamps; and
providing one or more temporal search suggestions based on the trending topics and the plurality of events, the one or more temporal search suggestions being responsive to a search query of a user.

8. The computer program product as claimed in claim 7, wherein the real-time data is obtained as a feed.

9. The computer program product as claimed in claim 7, wherein the plurality of events is extracted as triple data.

10. The computer program product as claimed in claim 7, wherein the one or more temporal search suggestions comprises search suggestions along with the associated timestamps.

11. The computer program product as claimed in claim 7, wherein providing the one or more temporal search suggestions comprises:
detecting if one or more of the plurality of events is associated with at least one of the trending topics.

12. The computer program product as claimed in claim 7, wherein the user submits the search query in a search box.

13. A system for providing temporal search suggestions in real-time, the system comprising:
an electronic device;
a communication interface in electronic communication with the electronic device;
a memory that stores instructions; and
a processor further comprising
a real-time data unit that obtains real-time data from one or more websites;
a trending topic detector that detects one or more trending topics associated with the real-time data;
an event extractor unit that extracts a plurality of events from the real-time data; and
a search suggest unit that provides one or more temporal search suggestions based on the trending topics and the plurality of events.

14. The system as claimed in claim 13 and further comprising
an event storage device that stores the plurality of events along with associated timestamps.

15. The system as claimed in claim 13 and further comprising
an electronic storage device that stores the real-time data from one or more websites, and the one or more trending topics associated with the real-time data.

16. The system as claimed in claim 13, wherein the real-time data is obtained as a feed,

17. The system as claimed in claim 13, wherein the plurality of events is extracted as triple data.

18. The system as claimed in claim 13, wherein the one or more temporal search suggestions comprises search suggestions along with the associated timestamps.

19. The system as claimed in claim 13, wherein the one or more temporal search suggestions are responsive to a search query of a user.

20. The system as claimed in claim 19, wherein the user submits the search query in a search box.
